(19) United States
(12) Patent Application Publication
(10) Pub. No.: US 2007/0222993 A1
(43) Pub. Date: Sep. 27, 2007

(54) Filter Unit Having a Tunable Wavelength, and an Arrangement with the Filter Unit

(76) Inventor: Patrick Linder, Mandach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/589,085

(22) PCT Filed: Feb. 9, 2005
(86) PCT No.: PCT/CH05/00069

§ 371 Date: Jun. 13, 2007

(30) Foreign Application Priority Data
Feb. 11, 2004 (CH) PCT/CH04/00080
Sep. 2, 2004 (EP) 04020810.0

(51) Int. Cl. G01N 21/25

(52) U.S. Cl. 356/416

(57) ABSTRACT

A filter unit (10) for filtering light comprising a first mask (3) with first cavities, a prism unit (7) and a second mask (8) with second cavities. The prism unit (7) is located between the two masks (3, 8), the first (3) and the second mask (8) having corresponding first and second cavities, which form cavity pairs. At least one second cavity in the second mask (8) is provided for each first cavity in the first mask (3). In addition, one prism is provided in the prism unit (7) for at least one pair of cavities. This produces an accurate, narrow-band filter unit. An assembly comprising the filter unit and a device for capturing images are also disclosed.

### RELATED APPLICATION

This application is a U.S. national phase application under 35 U.S.C. §371 of International Application No. PCT/CH2005/000069 filed Feb. 9, 2005, which claims priority of International Application No. PCT/CH2004/00080 filed Feb. 11, 2004 and European Application No. 04020810.0 filed Sep. 2, 2004.

### TECHNICAL FIELD

The present invention relates to a filter unit for filtering light, having a first mask and a prism unit, an arrangement having the filter unit, and an apparatus for acquiring images.

### BACKGROUND

Optical color filters in the nature of optical lenses, for example, are used for filtering light. Experience teaches that many such color filters, along with other disadvantages, exhibit damping, which is present even in the passband of the color filter. So-called Fabry-Perot filters, which can exhibit damping of up to 50%, are cited as representative of known color filters.

The known color filters are also employed, in particular, with a phototransistor unit or a photodetector. This is a photosensitive layer in front of which the color filter is arranged so that only a certain wavelength or a certain wavelength range can reach the photosensitive layer. Such arrangements having color filters for limitation to certain wavelengths or wavelength ranges are known per se, these exhibiting in particular the disadvantage of high damping of the light having the wavelength of interest, that is, even in the passband of the color filter.

Thus the measurement results, based on the intensity measured in the passband of the color filter, contain errors, in part substantial. What is more, the known color filters cannot be well adjusted. This also applies in particular to color filters based on liquid crystals, which are moreover temperature-dependent and relatively sluggish. Further, they are laborious to implement and consequently associated with high costs.

Known from German Offenlegungsschrift DE 44 16 314 A1 is an apparatus for sampling an image scene having imaging means, a reflecting component and a sensor arrangement for serial, point-by-point sampling of the image scene. Mirror surfaces of a mirror surface arrangement, movable independently of one another, are driven in a fashion temporally independent of one another, which necessitates an extremely complicated mechanical arrangement.

German Offenlegungsschrift DE 37 37 775 A1 describes a method for measuring the density values of a copy original. Here, with the aid of a spectrometer arrangement, a measuring light passing through the copy original is broken down into at least one color spectrum, the light intensity is measured separately in the individual wavelength ranges of this spectrum, and every measured value is determined with a the spectral sensitivity of the copy material in question. To this end, a single mechanically size-adjustable hole of a mask is moved over the copy original. This too is consequently a relatively laborious mechanical design, which is susceptible to error and accordingly expensive. A similar teaching can furthermore be inferred from DE 692 18 150 T2.

### SUMMARY OF INVENTION

It is therefore the goal of the present invention to identify a filter unit that does not exhibit the disadvantages listed above.

This goal is achieved by the filter unit of the invention for filtering light, having a first mask and a prism unit, wherein the first mask exhibits a plurality of first apertures; wherein there is a second mask having second apertures, the prism unit being arranged between the two masks; the first mask and the second mask exhibiting corresponding first and second apertures and forming an aperture pair; and wherein there is a prism in the prism unit for at least one aperture pair. Advantageous developments of the invention, an arrangement having the filter unit, and an apparatus for acquiring images are identified in further claims.

The invention exhibits the following advantages: In that there are a first mask having first apertures, a microprism unit and a second mask having second apertures, the microprism unit being arranged between the two masks, in that further the first mask and the second mask exhibit corresponding first and second apertures and form an aperture pair, there being at least one second aperture in the second mask for each aperture in the first mask, and finally in that there is a prism in the microprism unit for at least one aperture pair, a precise, narrow-band filter unit is obtained, which, by virtue of a multiplicity of corresponding first and second apertures arranged in a row or a matrix (array), makes possible a luminous efficiency increased relative to known arrangements. Aligning all the aperture pairs to a certain wavelength or to a certain wavelength range at the output of the filter unit by addition of the radiation passing through all the aperture pairs thus yields larger signal components, which in the case of further processing, for example with the aid of a photosensitive layer, leads to more accurate results or to results that are actually measurable.

If a multiplicity of aperture pairs are employed for measuring a certain wavelength or a certain wavelength range with the aid of a phototransistor as photosensitive layer, tiny input signals can be measured, because the signal components passing through the various aperture pairs are initially added. Addition of all the signal components is effected for example directly by the receiving phototransistor. In many applications it is only in this way that the phototransistor is stimulated enough to be able to obtain a measurable signal at all.

What is more, the filter unit according to the invention is distinguished by one or more of the following advantages:
The passband can be adjusted in the wavelength range of for example 1400 nm to 430 nm, the passband being dependent on the physical properties of the microprism unit employed. The accuracy of the passed wavelengths is dependent on the accuracy of the slit mask or hole mask. In one embodiment, provision is made for obtaining a gradation in steps of 0.5 nm.
Both polarized and unpolarized light can be filtered.
The microprism unit exhibits a very small light loss, because the light is merely refracted and not diffracted. A distribution over a plurality of maxima, as is the case in diffraction, does not take place when the light is refracted.
The properties of the filter unit, in particular the wavelengths passed, can be tuned electronically.
The filter unit according to the invention can be implemented as extremely small.
The fabrication effort and the fabrication costs are relatively low.

In what follows, the invention is described in greater detail with reference to the embodiments illustrated in the drawings. These are exemplary embodiments that aid in understanding the subjects claimed in the claims.

### BRIEF DESCRIPTION OF DRAWINGS

FIG. 1 depicts a filter unit according to the invention having a photosensitive layer;

FIG. 2 depicts a further embodiment of the filter unit according to the invention, in perspective representation;

FIG. 3 depicts a microprism unit for employment in the filter unit according to the invention;

FIG. 4 depicts two masks lying one over the other for tuning the wavelengths to be passed;

FIG. 5 depicts an application of the filter unit according to the invention in an image sensor;

FIG. 6 depicts a further embodiment of a filter unit according to the invention having a photosensitive layer, in perspective view; and

FIG. 7 depicts a further embodiment of an inventive filter unit having a photosensitive layer.

### DETAILED DESCRIPTION

FIG. 1 depicts a phototransistor unit 1 according to the invention, which essentially comprises a photosensitive layer 2, which is implemented for example with one or more phototransistors, and a filter unit 10 arranged in front of photosensitive layer 2. Filter unit 10 exhibits a movable slit mask 3, a microprism unit 7, and a fixed slit mask 8. Movable slit mask 3 can be moved in the directions indicated by an arrow 5, substantially laterally with respect to slit mask 8, and specifically with the aid of displacement units 4 and 6 arranged to the side of movable slit mask 3. In a specific embodiment, one displacement unit 4 is implemented with the aid of a piezounit and the other displacement unit 6 as a viscous spring element. Here the viscous spring element comprises for example a silicone insert, or an insert made of natural rubber or a steel spring. When a silicone insert is employed, a buffer layer is necessary in order to prevent material migrations.

A further concrete embodiment for displacement elements 4 and 6 consists in the employment of microsteppers or microlinear motors, which likewise make high precision possible in the displacement of movable mask 3.

According to the invention, prism unit 7 is arranged between fixed slit mask 8 and movable slit mask 3, masks 3, 8 exhibiting corresponding first and second apertures that form an aperture pair. Prism unit 7 exhibits a prism for at least one aperture pair.

In a further embodiment of the arrangement according to the invention, which is not illustrated in FIG. 1, instead of movable slit mask 3 the position of microprism unit 7 is altered with the aid of displacement units, which in turn are implemented for example in the form of a piezounit and a viscous spring element. In this way it is also possible to convey selectively those light waves L through slit mask 4, which in contrast to the embodiment according to FIG. 1 is now positionally fixed, onto photosensitive layer 2. Microprism unit 7 is moved substantially laterally to slit mask 3 or slit mask 8.

Yet a further embodiment of filter unit 10 according to the invention consists in that both the slit masks are movable. In this way, excursions of the individual slit masks are reduced because each of the slit masks is moved by half the distance to be covered. The slit masks in this case move in laterally contrary fashion.

Filter unit 10 described thus represents a color filter in which the filtered wavelengths can be tuned in electronic fashion. Moreover, filter unit 10 is a temperature-independent color filter that is tunable for example to wavelengths from 1400 to 430 nm. Filter unit 10 and therefore entire phototransistor unit 1 are distinguished by one or more of the following advantages:
The structural form of filter unit 10 or of phototransistor unit 1 can be chosen to be extremely small;
Precise electronic tunability of the desired wavelength of those light rays that are to impinge on photosensitive layer 2;
Minimal mechanical effort;
Extremely short reaction times;
Enhancement of the sensitivity of phototransistor unit 1 when all the aperture pairs are tuned to a wavelength, or the same wavelength range, in which measurement is to be performed. Specifically, the signals measured on the photosensitive layer can then be added, which leads to larger signal components.

In order that accurate measurement results can be obtained with phototransistor unit 1 according to the invention, a calibration must be carried out ahead of time. Such a calibration can for example be performed as follows:

Phototransistor unit 1 is exposed to a light source having a known wavelength. Movable slit mask 3 or 8—or, as appropriate, microprism unit 7, provided this is movable—is then displaced with the aid of displacement units 4, 6 until a signal maximum is obtained on photosensitive layer 2. The corresponding degree of displacement in dependence on the displacement mechanism employed can be held constant for calibration. If piezoelements are employed as active displacement units, the electrical signal applied to the piezoelements can be related to the wavelength of the light source, so that the calibration for this wavelength is complete. Further calibrations with other wavelengths of the light sources are advantageously carried out in order to ascertain nonlinearities, if any.

It has been found that microprism unit 7 can be fabricated from a substance having the chemical formula NaCl in crystalline form.

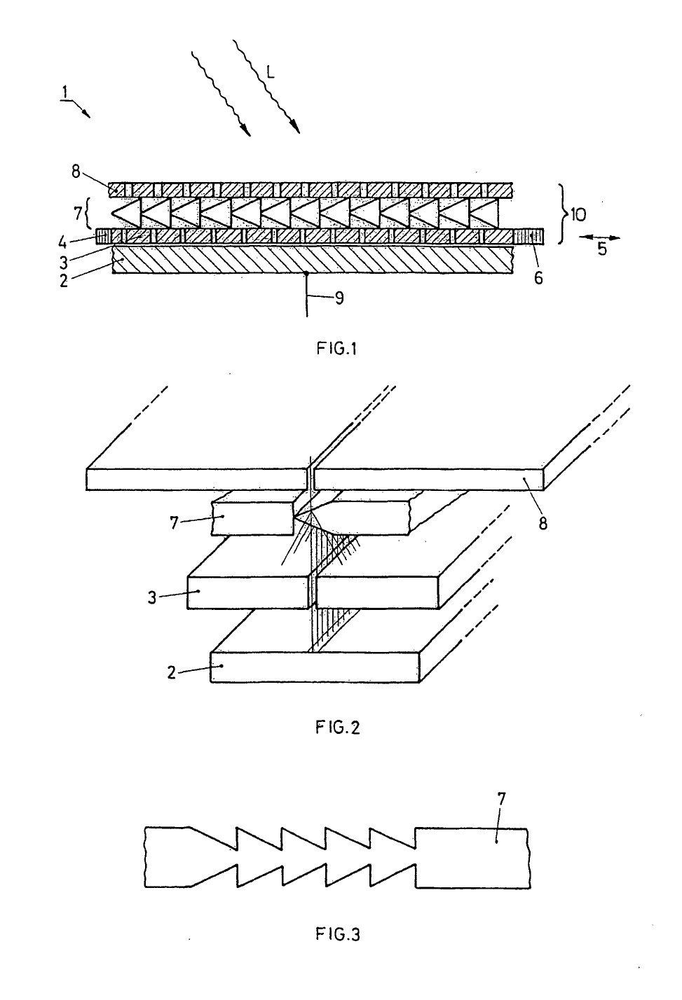

FIG. 2 depicts, in perspective representation, a further embodiment of the filter unit according to the invention. In contrast to the embodiment according to FIG. 1, this embodiment exhibits just one slit in slit masks 3 and 8. Microprism unit 7 correspondingly exhibits a single prism. An incident light beam is parallelized by slit mask 8. The parallelized light beam is then broken down by microprism unit 7 into light components of various wavelengths. The light component of interest is selected with the aid of movable slit mask 3 by positioning movable slit mask 3 appropriately. In this way it is brought about that only the light having the desired wavelength falls on photosensitive layer 2 and is measured.

A further embodiment of the present invention consists in employing hole masks instead of slit masks. In this way the corresponding images on the photosensitive layer become not strip-shaped but dot-shaped.

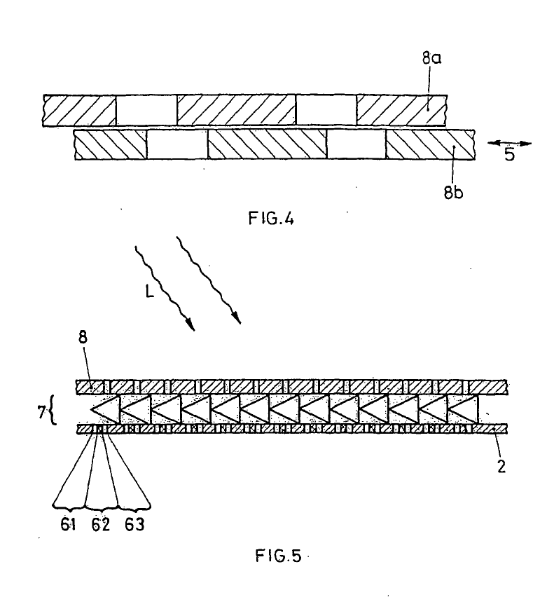

FIG. 3 depicts a microprism unit 7 as it is employed for example in the embodiment according to FIG. 1. Microprism unit 7 is fabricated for example from glass into which the individual prisms have been ground. In the fabrication of the microprism unit it should be noted that the individual prisms are in accordance with the corresponding dimensions of the slit masks or hole masks, that is, that the arrangement of a slit or a hole coincides with the corresponding prism, so that the desired wavelengths or wavelength ranges can be measured. The corresponding slits or holes are generally designated as aperture pairs, which correspondingly comprise first and second apertures.

In a further embodiment, microprism unit 7 is made of a polymer instead of glass. Fabrication is simplified in this way and the costs are less than when glass is employed. Combining individual prisms in order to form the microprism layer is also conceivable. The individual prisms are then cemented together with an adhesive.

As has become clear from the foregoing discussion, in particular in connection with the variant embodiments according to FIG. 1 to 3, an application of the filter unit according to the invention consists in combining the filter unit with a photosensitive layer 2. In this way a phototransistor unit is obtained with which extremely accurate measurements can be made in a certain wavelength range, the invention making possible electronic tuning of the wavelength to be measured.

A further embodiment of the filter unit according to the invention consists in that the wavelengths passed by the slit mask or hole mask are tunable. Provided to this end as the mask are two masks lying one over the other, as they are identified in FIG. 1 with the reference characters 3 and 8, which masks can be laterally displaced one relative to the other. Such an embodiment is illustrated in FIG. 4, two masks 8a and 8b lying one directly over the other, which masks can be laterally displaced one relative to the other—for example once again with piezoelements in combination with viscous spring elements. In this way the slit size or hole size is altered; consequently, there is obtained a slit mask or hole mask in which the aperture is adjustable. Depending on the application, the slit mask or hole mask having an adjustable aperture can be above the microprism unit, that is, on the side of light source L, or beneath the microprism unit. Moreover, it is also conceivable that the aperture of the slit masks or hole masks is adjustable in the sense of the foregoing discussion both above and also beneath the microprism unit.

A further application of the filter unit according to the invention consists in employing an image sensor, for example of the CCD (charge-coupled device) type, as the photosensitive layer, so that it becomes possible to use the present invention in camera technology, in particular in digital camera technology, a further embodiment then consisting in that there is no movable, but only one positionally fixed, slit mask or hole mask over the photosensitive layer or over the CCD sensor.

Such an application is illustrated in FIG. 5. It essentially comprises a hole mask 8, which is arranged above prism unit 7, and a photosensitive layer 2, which is implemented for example with the aid of photodiodes or phototransistors as photoelements, the photoelements being arranged in such fashion that for every hole in the hole mask, that is, for every pixel, there are three photoelements 61, 62, and 63. Here photoelement 61 is arranged in the region of red light, that is, light rays having wavelengths around 700 nm are incident; photoelement 62 is arranged in the region of green light, that is, light rays having wavelengths around 520 nm are incident; and photoelement 63 finally is arranged in the region of blue light, that is, wavelengths around 470 nm are incident. It is pointed out that for photographic applications it is therefore not necessary to arrange a second mask in front of the photosensitive layer. It is sufficient if there are three photoelements for every pixel. Thus a second hole mask or slit mask is necessary only in the case of a more accurate gradation of the passed wavelengths.

From FIG. 5 it can be inferred that there is a prism of prism unit 7 for one aperture in mask 8. It is conceivable that a prism unit 7 comprises rod-shaped prisms that extend over a row of apertures (in an embodiment having a hole mask). Then there are photoelements 61, 62, and 63 for every aperture in mask 8.

A further embodiment of the photographic application mentioned consists in that a photoelement in the range of ultraviolet light and/or in the range of infrared light is additionally arranged next to the photoelements for red, green, and blue. Of course, the photoelements for red, green, and blue light can even be omitted in this case.

A further embodiment consists in applying the above-named principle both to normal image recordings and to photographic paper, which results in a better yield of incident light. In particular, high-resolution black-and-white images can be generated in this way. These are in particular high-resolution spectral-raster images, which can for example be implemented with the following variant embodiment according to the present invention:

Analogously to the variant embodiment according to FIG. 5, here a hole mask and a microprism layer 7 are arranged one over the other. Instead of the photosensitive layer 2 illustrated in FIG. 5, a fine-grained monochrome photographic paper of the highest possible sensitivity or a corresponding photographic film is arranged. The incident light is rasterized by hole mask 8 and broken down into the spectral colors by microprism layer 7. In conventional black-and-white (raster) photography, a fixed gray-scale value is imaged at every raster point, and an image of an object is created with a plurality of raster points. By means of microprism layer 7, the entire spectrum of the light incident on this raster point is imaged, similarly to a barcode item of information, instead of the simple gray-scale value. In this way, the complete spectrum at every pixel is imaged in gray-scale values. In analyses, it thus becomes possible to identify or localize even the smallest color changes (in particular changes in reflectance and absorptance). In the case of both organic and inorganic reactions, this embodiment of the invention makes it possible to gain knowledge that makes possible conclusions as to the quality and structure of objects under study. Possible applications are for example the following:

determination of the finest changes in the skin;

chemical reaction photographs in plants;

etc.

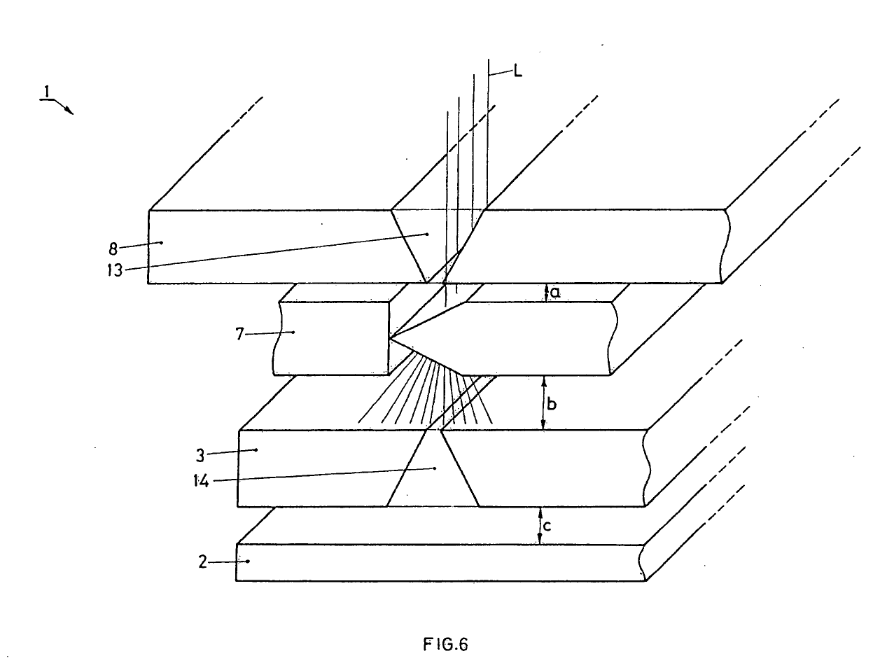

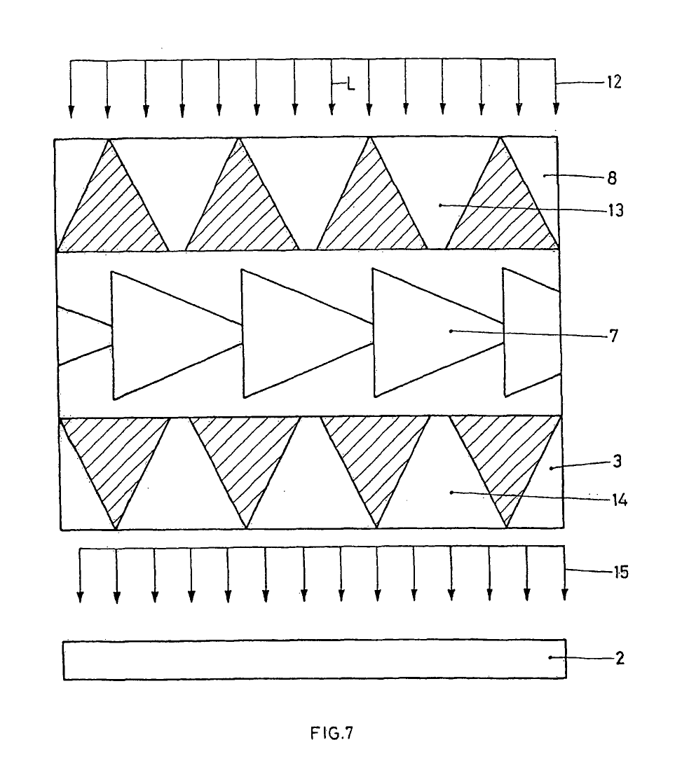

FIG. 6 depicts a further embodiment of a filter unit 1 according to the invention having a movable slit mask 8, a prism unit 7, a fixed slit mask 3, and a photosensitive layer 2 corresponding to the embodiment illustrated in FIG. 2. In contrast thereto, the embodiment according to FIG. 6 exhibits on the one hand a movable slit mask 8, whose side walls forming the slit have a conical shape, and specifically the slit is narrower on the light exit side than on the light inlet side. On the other hand, fixed slit mask 3 likewise exhibits conically shaped side walls, but in reversed direction, so that the slit width is smaller on the light inlet side than on the light exit side. In other words, the slit width is smaller on the side of prism unit 7 than on the side of photosensitive layer 2.

In a variant embodiment, the slit of movable slit mask 8 is equipped with converging optics 13 and/or the slit of fixed slit mask 3 is equipped with a diffuser 14. While a larger quantity of light or rather a larger number of light quanta is obtained by converging optics 13 and falls on prism unit 7, light monochromatically exiting through prism unit 7 is distributed by diffuser 14 in substantially uniform fashion and over a large area of photosensitive layer 2. The net result is higher sensitivity of the phototransistor unit.

In FIG. 6, the distance between movable slit mask 8 and prism unit 7 is designated by a, the distance between prism unit 7 and the fixed slit mask by b, and the distance between fixed slit mask 3 and photosensitive layer 2 by c. It has been found that distances a and c are preferably chosen as small as possible. Distance b is preferably variable and thus serves to limit or adjust the bandwidth—or the wavelength range—of the light beams passing through the slit of fixed slit mask 3.

It is pointed out that the conical shape—that is, the steepness of the side walls bounding the slit—of fixed slit mask 3 is chosen in such fashion that the relevant measurement region on the photosensitive layer is illuminated in full-area fashion. In this way it is ensured that no errors will be present in the measurement results, since non-full-area illumination of a phototransistor generally leads to measurement errors.

FIG. 7 illustrates a further embodiment of the filter unit according to the invention having a photosensitive layer 2 having a plurality of slits or holes in slit mask or hole mask 8, analogously to the embodiment according to FIG. 1. The reference character 12 characterizes mixed light and 15 characterizes monochromatic light, the latter alone being incident on photosensitive layer 2.

In the embodiment having a movable slit mask 8, the side walls forming the slit have a conical shape, the slit aperture being chosen as a maximum on the light inlet side, so that as much light as possible can be incident in each slit. Correspondingly, the side walls forming the slits come together to a point, which in each case coincides with the top side of movable slit mask 8. On the other hand, fixed slit mask 3 is arranged in the opposite way in the sense that the wide aperture comes to lie on the side of photosensitive layer 2. Diffuser 14 contained in the slit ensures that the photosensitive layer is maximally and uniformly illuminated, so that higher sensitivity and more accurate measurement results are obtained.

In a further embodiment of the invention, the conically shaped side walls of the slit are provided with a reflective coating in order to increase the luminous efficiency further.

In a further embodiment, for which the cross-sectional representation according to FIG. 7 is likewise valid, there are holes instead of slits in masks 8 and 3. The holes in masks 8 and 3 therefore have a truncated conical shape, as do the inserts let into masks 8 and 3 as converging lenses 13 in the case of movable hole mask 8, or as diffuser 14 in the case of fixed hole mask 3.

It is explicitly pointed out that—as already explained in connection with the embodiments according to FIGS. 1 and 2—movable mask 8 can also be fashioned as fixed and fixed masks 8 can be fashioned as movable, even in the embodiments according to FIGS. 6 and 7. What is more, constellations according to FIG. 4 are likewise conceivable in the embodiments according to FIGS. 6 and 7.

Finally, the embodiments according to FIGS. 6 and 7 are excellently suited for an image sensor, as was described with reference to FIG. 5.

It has already been pointed out that the microprism units are made of crystalline NaCl, glass or a polymer. Crystals, precious stones such as for example diamonds for high color purity, quartz, or neodymium are also conceivable.

It is pointed out that in all the embodiments previously mentioned, so-called multiple prisms can be employed in the microprism units or in the prism units. Such multiple prisms, also roughly called direct-vision prisms, are assembled from a plurality of prisms having various materials, for example various grades of glass, so that the central ray passes through substantially undeflected despite a spectral deflection. Further information on multiple prisms can be found for example in DE-37 37 775 A1.

1. A filter unit (10) for filtering light, having a first mask (3) and a prism unit (7), wherein the first mask (3) exhibits a plurality of first apertures; wherein there is a second mask (8) having second apertures, the prism unit (7) being arranged between the two masks (3, 8); the first mask (3) and the second mask (8) exhibiting corresponding first and second apertures and forming an aperture pair; and wherein there is a prism in the prism unit (7) for at least one aperture pair.

2. Filter unit (10) according to claim 1, wherein for each first aperture in the first mask (3) there is at least one second aperture in the second mask (8).

3. Filter unit (10) according to claim 1, wherein the first mask (3) is fixed relative to the prism unit (7) and the second mask (8), in relation to one of the first mask (3) and the prism unit (7), is displaceable substantially laterally with respect to the first mask (3) with the aid of at least one displacement unit (4, 6).

4. Filter unit (10) according to claim 1, wherein the first mask (3) is fixed relative to the second mask (8) and the prism unit (7), in relation to one of the first mask (3) and the second mask (8), is displaceable substantially laterally with respect to the second mask (8) with the aid of at least one displacement unit (4, 6).

5. Filter unit (10) according to claim, wherein the at least one displacement unit (4, 6) is arranged to the side of the unit (7, 8) to be displaced.

6. Filter unit (10) according to claim 3, wherein the at least one displacement unit (4, 6) comprises a piezounit.

7. Filter unit (10) according to claim 3, wherein there are two displacement units (4, 6), one being a piezoelement and the other being a viscous spring element.

8. Filter unit (10) according to claim 3, wherein the at least one displacement unit (4, 6) is selected from the group consisting of a microstepper motor and a microlinear motor.

9. Filter unit (10) according to claim 1, wherein the prism unit (7) is made of at least one of the substances selected from the group consisting of:
glass;
crystalline NaCl;
polymers;
crystals;
precious stones including diamonds;
quartzes;
neodymium.

10. Filter unit (10) according to claim 9, wherein said prism in the prism unit is ground or etched into glass.

11. Filter unit (10) according to claim 1, wherein the prism unit (7) is made of a polymer.

12. Filter unit (10) according to claim 1, wherein the first mask and the second mask (3, 8) are selected from the group consisting of slit masks and hole masks.

13. Filter unit (10) according to claim 12, wherein the side walls of the slit masks forming the slits and the side walls of the hole masks forming the holes are one of conically shaped and in the shape of a truncated cone.

14. Filter unit (10) according to claim 13, wherein the first mask (8) exhibits first apertures that are smaller on the side of the prism unit (7) than on the opposite side.

15. Filter unit (10) according to claim 12 wherein the second mask (3) exhibits second apertures that are smaller on the side of the prism unit (7) than on the opposite side.

16. An arrangement having a filter unit (10) for filtering light, having a first mask and a prism unit, wherein the first mask exhibits a plurality of first apertures; wherein there is a second mask having second apertures, the prism unit being arranged between the two masks; the first mask and the second mask exhibiting corresponding first and second apertures and forming an aperture pair; and wherein there is a prism in the prism unit for at least one aperture pair and said arrangement further including a photosensitive layer (2), the photosensitive layer (2) being arranged adjacent to the second mask (3).

17. The arrangement of claim 16, wherein the photosensitive layer (2) comprises at least one of phototransistors and image sensors.

18. The arrangement of claim 17, wherein the photosensitive layer (2) comprises an image sensor of the charge-coupled device type.

19. An apparatus for acquiring images comprising: a first mask (3) having first apertures, a prism unit (7) and a photosensitive layer (2), the prism unit (7) being arranged between the first mask (3) and the photosensitive layer (2), and the photosensitive layer (2) comprehending at least three regions in which the incident light is measurable, the light falling on the at least three regions originating from the same first aperture.

20. Apparatus according to claim 19, wherein red light is measurable in a first region, green light in a second region, and blue light in a third region.

21. Apparatus according to claim 19, wherein the first mask (3) is of the hole mask type.

22. Apparatus according to claim 19, wherein light is measurable in a further region into which ultraviolet light falls.

23. Apparatus according to claim 19, wherein light is measurable in a further region into which infrared light falls.

24. Apparatus according to claim 19, wherein the first mask (3) is of the mask type with side walls forming holes as said first apertures in the form a truncated cone.

25. Apparatus according to claim 24, wherein the first apertures of the first mask (8) are smaller on the side of the prism unit (7) than on the opposite side.
